(19) United States
(12) Patent Application Publication
(10) Pub. No.: US 2026/0172438 A1
(43) Pub. Date: Jun. 18, 2026

(54) SYSTEM AND METHOD FOR ASSESSING THE RISK PRESENTED BY FUTURE VULNERABILITIES WITHIN AN ORGANIZATION'S TECHNOLOGY AND THIRD PARTY SERVICES

(71) Applicant: Kovrr Risk Modeling, Ltd., Tel Aviv (IL)

(72) Inventors: Peter Dyson, London (GB); Oren Koriat, Tel Aviv (IL); Yakir Golan, Kibbutz Yagur (IL); Shai Yanovski, Tel Aviv (IL); Amir Shur, Haifa (IL)

(21) Appl. No.: 18/978,033

(22) Filed: Dec. 12, 2024

(51) Int. Cl. H04L 9/40; H04L 41/14; H04L 41/22

(52) U.S. Cl. CPC H04L 63/1433; H04L 41/145; H04L 41/22

(57) ABSTRACT

A computer-implemented method for assessing risk presented by future vulnerabilities within an organization's technology and third party services, including: accessing a catalog of a plurality of previously reported vulnerabilities; classifying technologies affected by the plurality of previously reported vulnerabilities according to product type; classifying technologies affected by the plurality of previously reported vulnerabilities according to vendor; accessing additional data characterizing the exploitability, severity and risk of vulnerabilities within the catalog; computing a product-type risk adjuster for each previously reported vulnerability; computing a vendor risk adjuster for each previously reported vulnerability; simulating a number of cyber events, each embodying one of the plurality of vulnerabilities, to predict whether an organization is affected by the simulated cyber event, wherein the cyber event simulates malicious activity, wherein the simulation is adjusted by the product-type risk adjustor and the vendor risk adjustor; and estimating a damage of the cyber event on the organization.

### TECHNICAL FIELD

The present disclosure relates generally to event modeling and, more specifically, for modeling cyber events attributed to technology and services provided by third party vendors.

### BACKGROUND

As businesses have become more interconnected due to the ubiquitous use of the internet, new challenges arise which can threaten the security of a business. These threats include an increase in cyber and internet-based attacks. Such attacks can encompass traditional hacking, such as the insertion of malware within a network, phishing attacks to extract sensitive information, and distributed denial of services attacks. More recent trends have evolved that expose businesses to other types of attacks. These can include ransomware attacks, wherein a malicious entity gains access to a network and prevents the rightful owner from accessing their data, e.g., by encrypting servers and demanding payment for the decryption key.

These events, however, are not limited to intentional malicious actors acting directly on a particular company, e.g., by infecting the target's on-premises servers or databases. Many businesses rely heavily on third-party software and third-party providers, each of which may fail for a variety of reasons which significantly impact customers.

Supply chain attacks for example, which target a third-party software dependency, hardware component, or service provider within a specific technology's value chain, have risen in both prevalence and severity over the past few years. The 2023 MOVEit incident, for instance, impacted thousands of organizations and has been estimated to cost upwards of $12.25 billion, which, if correct, makes it one of the top 5 most expensive cyber attacks in history.

These types of attacks can be especially insidious as they are often hidden from the technology's users, difficult to track, and nearly impossible to contain. This catastrophic nature underscores the critical need to establish proactive, data-driven management approaches that specifically address technology-driven cybersecurity risks, minimizing both the likelihood of occurrence and the potential severity should such an event take place.

However, with the number of known vulnerabilities growing by roughly 20,000 on an annual basis since 2021, the rising adoption of cloud and software as a service (“SaaS”) solutions, and the increasing trend of organizations using a third-party service provider to manage devices and servers, patching all vulnerabilities within a technologically diverse environment is an insurmountable task.

It would therefore be advantageous to develop a risk-prioritization strategy to allow security teams to identify software, vendors and technology which has a high probability of experiencing significant vulnerabilities in the future. This will allow for a focused deployment of security controls put in place, proportionate to the level of risk introduced, and the expected use of the technology. This approach will also align with business goals by focusing on the technologies that are most likely to be exploited by threat actors in the wild and cause material financial harm.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” may be used herein to refer to a single embodiment or multiple embodiments of the disclosure.

Certain embodiments disclosed herein include a computer-implemented method for assessing the risk presented by future vulnerabilities within an organization's technology and third party services, including: accessing a catalog containing one or more descriptors for a plurality of previously reported vulnerabilities; referencing the one or more descriptors, classifying technologies affected by the plurality of previously reported vulnerabilities according to product type; referencing the one or more descriptors, classifying technologies affected by the plurality of previously reported vulnerabilities according to vendor; accessing additional data characterizing the exploitability, severity and risk of individual vulnerabilities within the catalog; based on the additional data, computing a product-type risk adjuster for each of the previously reported vulnerabilities; based on the additional data, computing a vendor risk adjuster for each of the previously reported vulnerabilities; simulating a number of cyber events, each embodying one of the plurality of vulnerabilities included in the catalog, to predict whether an organization is affected by the simulated cyber event, wherein the simulating cyber event simulates malicious activity in the organization, and wherein the simulation is adjusted by the product-type risk adjustor and the vendor risk adjustor; and estimating a damage of the cyber event on the organization by employing a damage function.

Certain embodiments disclosed herein also include a non-transitory computer readable medium having stored thereon instructions for causing a processing circuitry to execute a process for assessing the risk presented by future vulnerabilities within an organization's technology and third party services, the process including: accessing a catalog of reported vulnerabilities containing one or more descriptors for a plurality of previously reported vulnerabilities in technologies; referencing the one or more descriptors, classifying technologies affected by the plurality of cyber events according to product type; referencing the one or more descriptors, classifying technologies affected by the plurality of cyber events according to vendor; accessing additional data characterizing the exploitability, severity and risk of individual vulnerabilities within the catalog; based on the additional data, computing a product-type risk adjuster for each of the previously reported vulnerabilities; based on the additional data, computing a vendor risk adjuster for each of the previously reported vulnerabilities; simulating a plurality of cyber events, each embodying one of the plurality of vulnerabilities included in the catalog, to predict whether an organization is affected by the simulated cyber event, wherein the simulating cyber event simulates malicious activity in the organization, and wherein the simulation is adjusted by the product-type risk adjustor and the vendor risk adjustor; and estimating a damage of the cyber event on the organization by employing a damage function.

Certain embodiments disclosed herein also include a system for calculating technology risk, including: a processing circuitry; and a memory, the memory containing instructions that, when executed by the processing circuitry, configure the system to: excess a cyber event catalog containing one or more descriptors for a plurality of previously reported vulnerabilities in technologies; reference the one or more descriptors, classify technologies affected by the plurality of cyber events according to product type; reference the one or more descriptors, classify technologies affected by the plurality of cyber events according to vendor; accessing additional data characterizing the exploitability, severity and risk of individual vulnerabilities within the catalog; based on the additional data, computing a product-type risk adjuster for each of the previously reported vulnerabilities; based on the additional data, computing a vendor risk adjuster for each of the previously reported vulnerabilities; simulate a plurality of cyber events, each embodying one of the plurality of vulnerabilities cyber events included in the catalog, to predict whether an organization is affected by the simulated cyber event, wherein the simulating cyber event simulates malicious activity in the organization, and wherein the simulation is adjusted by the product-type risk adjustor and the vendor risk adjustor; and estimate a damage of the cyber event on the organization by employing a damage function.

### BRIEF DESCRIPTION OF THE DRAWINGS

The invention may be best understood by reference to the following description taken in conjunction with the accompanying drawing figures in which:

FIG. 1 is a block diagram of potential risk sources and manifestations of those risks which are incorporated in prioritized event modeling, according to an embodiment;

FIG. 2 is an example flowchart illustrating a method of how the vulnerability risk feeds into the event generation process of an event simulation, according to an embodiment;

FIG. 3 is a graph showing an EP curve generated, according to an embodiment;

FIG. 4 is an example graph showing relative event frequency risk scores by product category;

FIG. 5 is an example graph showing relative event propagation scores by product category;

FIG. 6 is an example graph showing relative event frequency risk scores by product category;

FIG. 7 is an example graph showing relative event propagation risk scores by vendor;

FIG. 8 is a graph showing the breakdown of the overall risk adjustment made to frequency for an example technographic profile;

FIG. 9 is a bar chart showing relative contributions to a subset of infrastructure assets at an organization;

FIG. 10 is a network diagram illustrating a deployment of a system, according to an embodiment; and

FIG. 11 is a block diagram of the system, according to an embodiment.

### DETAILED DESCRIPTION

Embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for capturing the risk presented by vulnerabilities, to allow the creation of cyber events within a risk model. The method includes employing a modeling framework that addresses events that affect third parties, including service providers that provide off-premises services, such as cloud computing, and technology providers that provide on-premises software used by other companies.

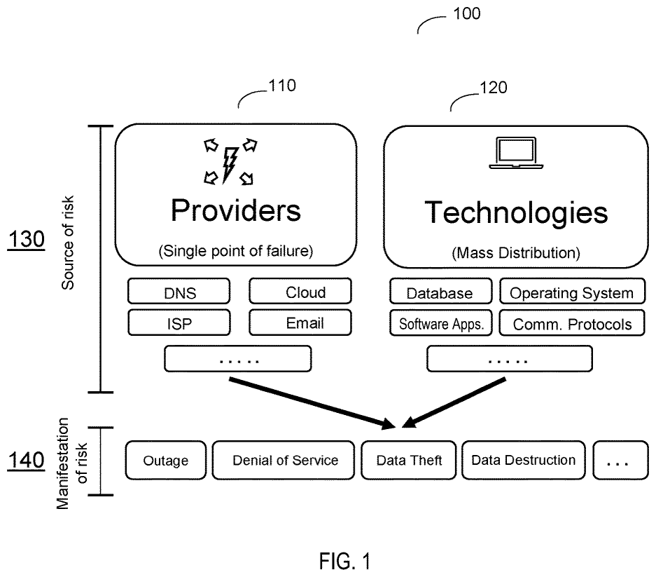

Now, referring to the drawings wherein identical reference numerals denote the same elements throughout the various views, FIG. 1 illustrates an example block diagram 100 of potential risk sources 130 and manifestations 140 of those risks which are incorporated in event modeling, according to an embodiment. The disclosed embodiment addresses two main risk sources that may trigger an event: risks that stem from third-party service providers 110, and risks that stem from third-party technology providers 120.

Third-party service providers 110 include shared services, e.g., services provided to multiple businesses or end users, that may be located remotely and accessed over a network, e.g., the internet. These third-party service providers 110 include internet service providers (ISPs), cloud computing or cloud storage providers, DNS providers, cloud email providers, data analysis providers, and the like. The services offered rely on hardware and software that are not based on the premises of the user of said services. For example, a DNS or email server may be operated from a remote location or distributed from multiple remote locations controlled by the provider. Third-party service providers 110 are vulnerable to a single point of failure, as a successful attack at one location, for example, a central server location of a shared DNS server providing DNS services to hundreds or thousands of clients, will negatively affect all clients that rely on that shared server immediately.

Third party technology providers 120 include providers of technologies which are created by a third party and distributed to many clients, such as software authored by a single entity but licensed to be used by many clients. Examples include operating systems, such as Microsoft® Windows®, database software, third-party software libraries, such as encryption libraries employed in web servers or point of sale devices, common protocols employed by many end users, and the like. Here, a flaw found in the software itself creates vulnerabilities in each system running the software, namely each individual client, rather than in a single central location.

A cyber event occurs when a service or technology is breached or attacked, such that clients are affected. In order to successfully determine the likelihood of a cyber event, a catalog is formed that includes various potential cyber events that are classified into multiple subclassifications. The subclassifications can then be analyzed and employed in simulations described further below. For third party service provider 110 events, the subclassifications include at least a provider type, and an impact type. The provider type includes categories of services, such as DNS, email, cloud computing and the like. An impact type defines how a business is affected by an event and the potential damage caused. This includes data loss, data theft, outages, and the like. In an embodiment, the catalog includes the provider types and impact types of past events.

For third party technology providers 120, the sub-classifications include the type of technology, such as databases, web servers, software libraries, and the like, as well as the impact type noted above, e.g., data loss, data theft, outages, and so on.

An additional subclassification is an event scope which includes information related to the geographical location of the event. Such a geographical location subclassification differs from a corresponding classification of a natural event in that, rather than being centered around where the event occurs, the location of a cyber event can be spread worldwide. For example, AWS® runs on servers located in many countries around the world. If a server in Virginia, USA, which serves clients in western Europe or southeast Asia, is successfully attacked, the clients'location is the relevant affected area, rather than the location of the server. Similarly, hardware built and sold by a U.S. company may be used by international businesses across the globe. Thus, the location of those affected by the attack must be determined and categorized for proper damage estimation, regardless of the location of the physical server.

The statistical distribution may be based on extrapolated data from past events. In an embodiment, this distribution is determined based on data collected from various users, where the data includes mapping service and technology providers to physical locations of its users. If an AWS® server in Virginia is configured to serve clients in Japan, a breach in the Virginia server will be associated with risk for clients in Japan.

Patching all vulnerabilities within a technologically diverse environment is an insurmountable task. In practice, cyber security teams must prioritize constrained resources in a way that aligns with business goals.

To aid cybersecurity teams in this prioritization process, the present inventors employ the Exploit Prediction Scoring System (“EPSS”), which provides an up-to-date reflection of security risk within software products and vendors. EPSS is a data-driven model designed to complement the Common Vulnerability Scoring System (“CVSS”) vulnerability enumeration standard. While the CVSS standard generates a continuous stream of in-depth technical details regarding various vulnerabilities, such as attack vectors, user interaction, and the type of data compromise, there is nevertheless significant room for improvement when trying to predict what vulnerabilities threat actors are actually going to exploit to compromise an organization. EPSS, on the other hand, attributes a machine-learning predicted score to every vulnerability, indicating how likely it is to be exploited in the wild within the next 30 days. By leveraging EPSS, vulnerabilities can be modeled with an organization's specific business objectives in mind.

Testing has shown that using EPSS can provide much greater coverage with less effort than CVSS alone.

The method described herein goes beyond simply ranking individual vulnerabilities by potential impact. Instead, it provides a comprehensive vulnerability risk overview of an organization. It does so by scoring technologies on a higher-level scope, enabling evaluation of every specific technological stack and assigns numerical risk adjustments to the frequency of successful attacks originating in or propagating into that organization.

These risk adjustments account for the added risk that certain technologies entail, or in some cases, the decreased risk in technologies that are less likely to be exploited. The basic methodology is as follows:

First, the system assesses the latest snapshot of full CVE descriptions/definitions and attaches EPSS score data for all known vulnerabilities and respective technologies.

Next technologies are classified according to product type (database, web server, etc.) and product type-related risk parameters are assigned.

Then, the technologies are grouped according to the operation the technology performs, and name of vendor and likewise vendor-related risk parameters are assigned.

The overall risk adjustment is then calculated from the aggregate risk of technologies used within the organization, applying a decaying function to account for the decreasing marginal risk from adding additional technologies.

Then, overall risk adjusters are assigned throughout the modeled entity based on the specific technological stack. These overall adjustments become inputs to a Monte Carlo simulation.

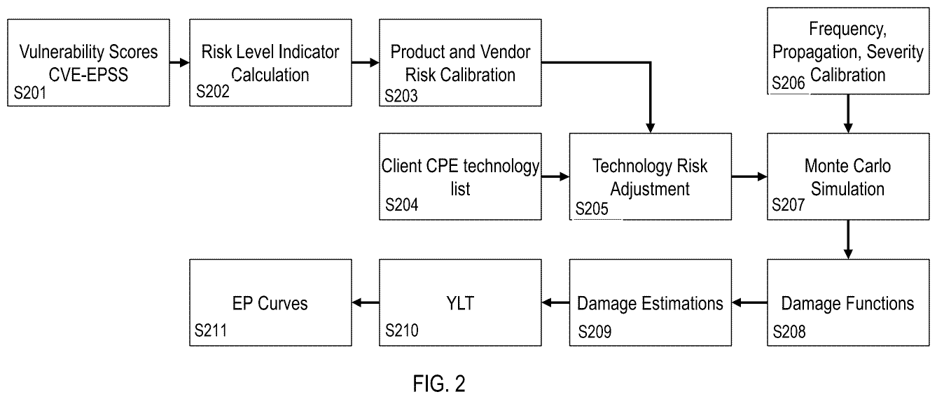

FIG. 2 is an example flowchart 200 illustrating a method of simulating events in a prioritized manner, according to an embodiment.

At S201, a current snapshot of CVE and EPSS data is obtained and assessed for all known vulnerabilities and respective technologies. The CVE data represents a catalog of reported vulnerabilities, containing one or more descriptors for each vulnerability. CVE data is available from MITRE Corporation. EPSS data is available from Forum of Incident Response and Security Teams, Inc. of Cary, North Carolina, USA (“FIRST”). The data is hosted at the website First. org. The EPSS Contains additional data characterizing the exploitability, severity and risk of individual vulnerabilities, indexed to CVE ids.

At S202, a risk level indicator calculation is performed on the EPSS data, to aggregate vulnerability info (CVE) and scores (EPSS) by product-vendor groups. The steps are generally as follows:
Split vulnerabilities into frequency impact and propagation.
Set threshold for “critical vulnerability” as EPSS score.
Aggregate scores by group.

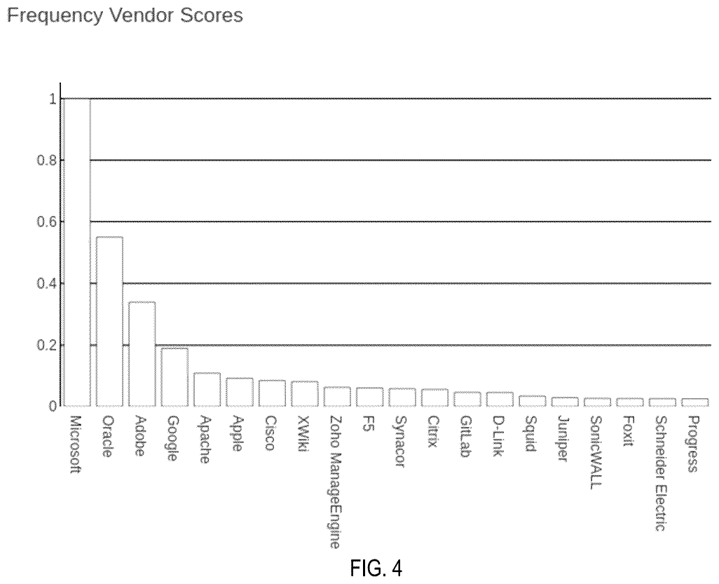

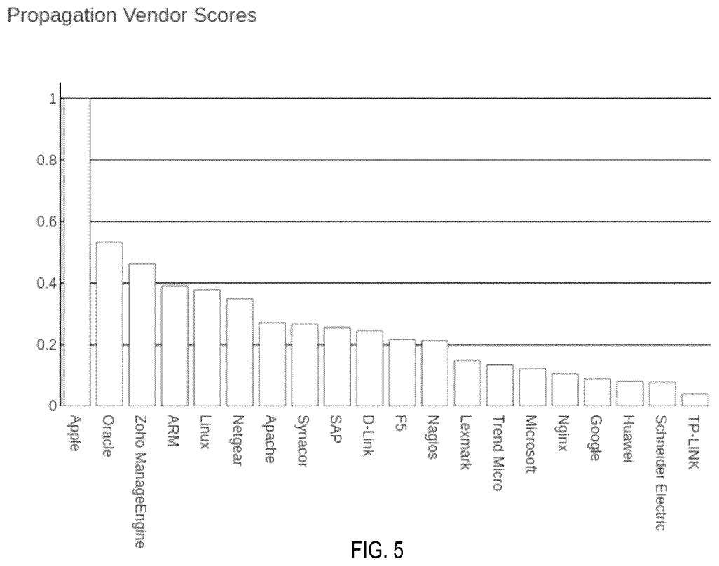

For each vulnerability, the technology or service is classified according to product type. Product types may include any product category that can be reliably identified from the intended function and operation of the service, software package or tool. In one nonlimiting example, the categories include: server applications, client applications, operating systems, products as a service, security, network applications, content management systems (“CMS”), infrastructure, web, remote access, Internet of Things (“IoT”), secure sockets layer (“SSL”), e-commerce, database, file transfer protocol (“FTP”), storage, medical, voice over Internet protocol (“VoIP”), email, hardware, domain name system (“DNS”), drivers, customer relationship management (“CRM”), printers. Appropriate computations are used to derive a relative frequency of exploitable vulnerabilities categorized for each type of vendor-product combination, and to assign product type-related risk scores. A chart shown in FIG. 4 is an example of how this data may be characterized if viewed by product-type, impacting the likelihood of a breach occurring (frequency of event). As one illustrative example, server applications may have a high chance of an exploitable vulnerability occurring with a relative risk value of 1.0, whereas Internet of Things (“IoT”) may have a lower risk of being exploited, at a relative risk value of approximately 0.05. This leads to the conclusion that in practice, a server application may have an exploitation risk approximately 20 times the risk of an IoT device. Risk scores are also generated based on propagation of an attack between connected devices. FIG. 5 is an example of how this data may be characterized.

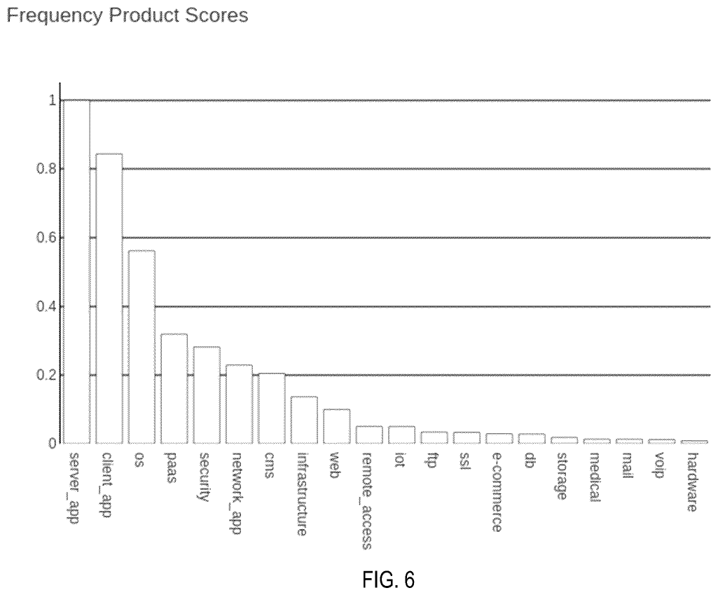

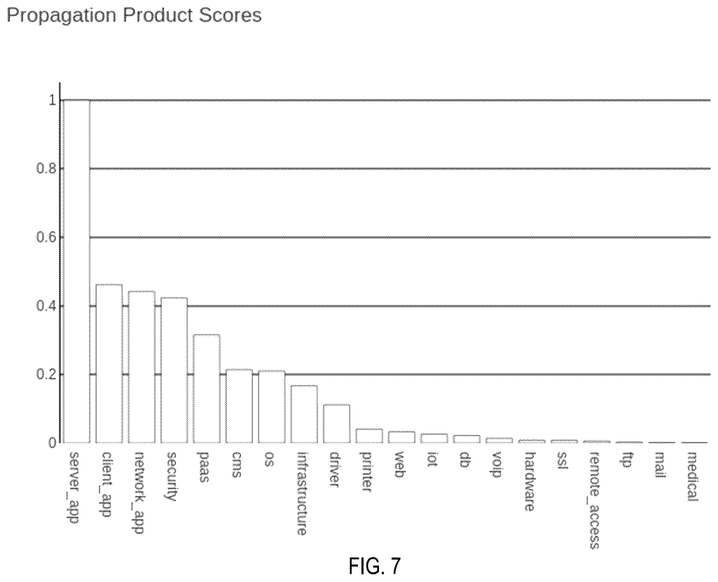

Also in step S203, for each vulnerability, the technology is classified according to vendor. Any vendor may be listed that can be reliably identified from the CVE data. Appropriate computations are used to derive a relative frequency of vulnerability categorized for each vendor, and to assign vendor-related risk scores. A chart shown in FIG. 6 is an example of how this data may be characterized. As one illustrative example, products supplied from MICROSOFT may be exploited at a relative frequency value of 1.0, whereas products supplied from CITRIX may be exploited at a relative frequency value of approximately 0.05. This leads to the conclusion that in practice, a MICROSOFT product may have an exploitation risk approximately 20 times the risk of a CITRIX product. Risk scores are also generated based on propagation of an attack between connected devices. FIG. 7 is an example of how this data may be characterized.

The result of this step is generation of product type risk adjustors and vendor risk adjustors.

It is noted that steps as S201-S203 described above can be performed as a precursor or preparatory process to making risk evaluations for a particular organization (i.e. a customer). For example, the EPSS data may be scanned and analyzed and the product and vendor risk scores assigned at regular intervals. These data are then available for use later.

At S204, the technology list for the modeled organization is compiled. This list may use the common platform enumeration (“CPE”) naming scheme. This list is a summary representation of assets (services and technologies) that are used by the client.

At S205, the product and vendor risk calibration and the client technology list are used to perform a technology risk adjustment.

In this process, an evaluation is made of the modeled entity's specific technological stack and numerical risk adjustments are applied to the frequency of successful attacks originating in or propagating into that technological stack.

Organizations that employ more risky technologies are adjusted to experience a higher exposure. Conversely, organizations that utilize less risky technologies are adjusted to experience lower exposure. Marginal contributions are fitted to a logarithmic curve to account for the diminishing effect of adding more technological variability into an environment.

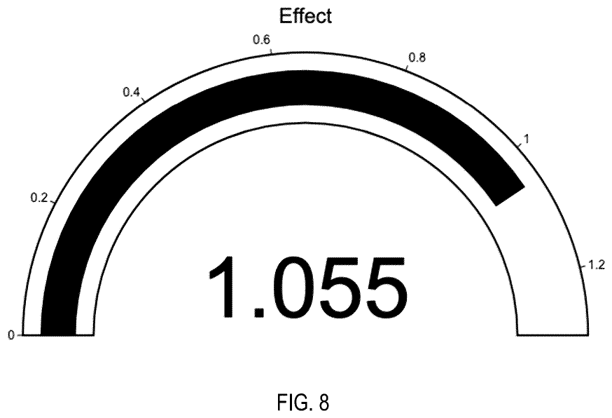

For example, FIG. 8 shows a hypothetical adjustment for a subset of infrastructure assets of a representative organization “Customer Inc.”. The gauge measuring 1.055 corresponds to a +5.5% adjustment for technology-related events compromising an organization's infrastructure assets. The +5.5% indicates that the organization's technological stack is 5. % more risky than the benchmark technological stack for similar comparable organizations.

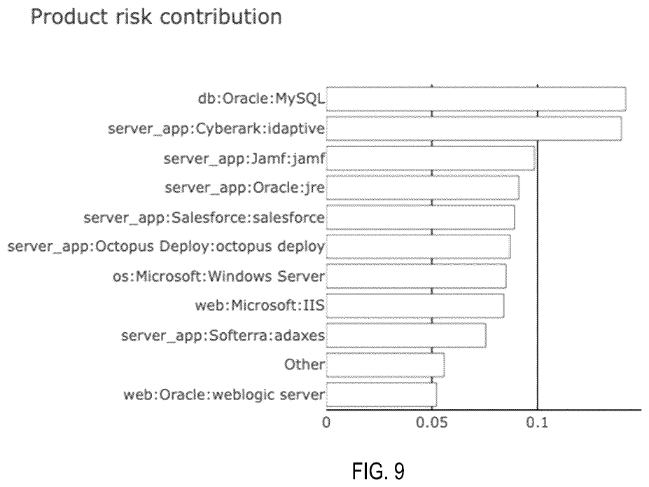

The related pie chart in FIG. 9 illustrates the distribution of the different technologies'contribution to the adjustment effect. In this example, ORACLE and MICROSOFT technologies are the greatest sources of technological risk in this modeled entity, with server applications provided by various vendors following close behind.

At S206, a calibration is performed taking into account frequency, propagation, and severity. This is the calibration of the base Monte-Carlo simulation, to which the product type and vendor risk adjustors are applied to adjust the simulation input. It contains event frequency, and probability of propagation between devices at the modeled entity, as well as damage costs and other descriptive properties.

At S207, a Monte Carlo simulation is run on the event catalog using the risk adjustments described above. The base calibration for the modeled entity from S206 is adjusted by the adjustors calculated in S205. The execution of the Monte Carlo simulation provides, for each year modeled, an assessment of whether the organization will be affected by cyber events, described in the catalog.

For each simulated year, a number of events simulated in that year is sampled from a Poisson distribution with a ‘λ’ parameter. The ‘λ’ parameter represents the average number of events that happen in a year, where the ‘λ’ parameter is determined based on an analysis of past event data. Thus, the probability that each event is chosen is the event's rate multiplied by the ‘λ’ parameter.

Separate frequencies are specified at the calibration [S206] for technology-based and provider-based events, the risk adjustments apply to the respective frequency, including both ‘targeted’ and ‘systemic’ events.

At S208, damage functions are employed to estimate the potential damage of simulated cyber events. The damage function's input is the local intensity of an event, and the function yields a damage factor. The local intensity parameter generation is further explained below. The damage factor indicates the estimated damaged percentage of the exposed value. A damage factor of 1 means a total loss of the exposed value, and a damage factor of 0 means the cyber event has had no effect.

A damage function is based on two or more parameters including, as examples and without limitation, industry, event type, coverage type, business size, business industry, business location, and the like. Each parameter has a direct relation to the proportion of damage caused. For example, a cyber event that caused a cloud outage will likely affect an e-commerce company more than the event will affect a law firm, as the cloud functions will likely tie more closely to the core business of the e-commerce company. Thus, such an event may trigger business interruption coverage for the e-commerce company, while failing to do so for the law firm.

It should be noted, however, that while, according to the example, the industry type parameter is the most relevant parameter in the above example, the damage function will likely also be affected by the other parameters, namely the event type, location, and coverage type. A change in any of these parameters will also change the damage estimation and, therefore, all parameters are needed in order to define the damage function. In an embodiment, historic incident data with financial impact, insurance claim data, academic research, and the like, are also used to determine the damage function value.

At S209, potential damages from cyber events are estimated. To calculate the event damage estimation, a local intensity factor is determined for each event. The local intensity of an event combines the intensity of the event and the amount of exposure of a portfolio entity, e.g., a single company.

The intensity of an event is derived from the event parameters. For example, an event with a long duration and a large scope will have a higher intensity than an event with a small scope and short duration.

The exposure of a portfolio to the event is derived from the hazard tables. For each company in the portfolio, the corresponding hazard data is used. The intensity and the exposure are then used to calculate the local intensity, and the damage function is used to determine the damage factor.

As an example, a damage factor may reflect the effect of an AWS outage in an Austrian data center on a company that uses that data center. If the intensity of the event is determined to be 0.5 and the exposure of the company for an AWS Austrian data center outage is 0.3, the local intensity is calculated by multiplying the exposure factor by the intensity factor. Thus:

$$exposure factor \times intensity factor = local intensity ( 0.3 \times 0.5 = 0.15 )$$

After calculating the local intensity, the relevant damage function is used to calculate the damage factor. In the current example, the relevant damage function yields a damage factor of 0.5 for a local intensity of 0.15. The damage factor can then be used to calculate the ground-up loss.

At S210, a yearly loss table (YLT) is created based on the damage estimations. The YLT is a table that contains all of the events from the Monte Carlo simulation, combined with the damage estimation per company for each event, and a brief description of the event, including metadata about the event. For example, a YLT may include a row indicating that, in year 3, a cloud storage vulnerability may be discovered, with an associated damage estimate of $940 million.

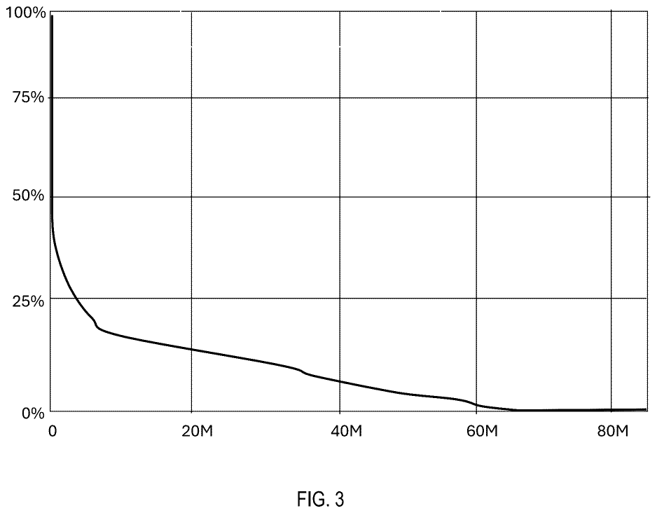

At S211, exceedance probability (EP) curves are determined. The determination of EP curves includes reducing the YLT by calculating an annual exceedance probability (AEP) by summing the damages of each year. This reduced table is used to plot the EP curve. An example graph showing the EP curve is described with respect to FIG. 3, wherein FIG. 3 is a graph showing the EP curve generated, according to an embodiment.

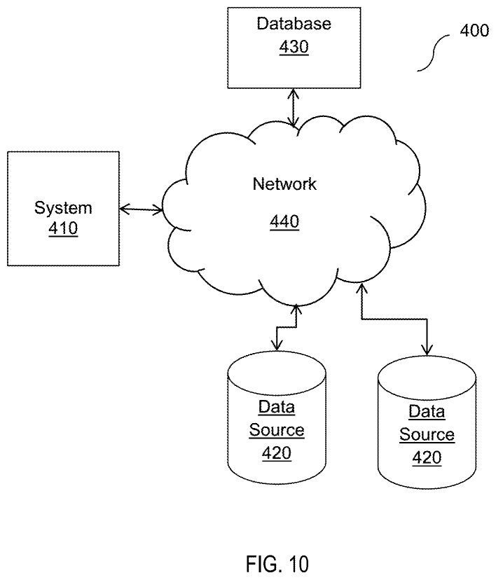

FIG. 10 shows an example network diagram 400 illustrating a deployment of a system 410 for event prioritization, according to an embodiment.

The diagram 400 depicts the system 410, a plurality of data sources 420, and a database 430 communicating over a network 440. The network 440 may be, but is not limited to, a wireless, cellular, or wired network, a local area network (LAN), a wide area network (WAN), a metro area network (MAN), the Internet, the world wide web (WWW), a network similar to those described, and any combination thereof.

In an example embodiment, the data sources 420 provide the data used in past event extrapolation. The data sources 420 may include Common Vulnerabilities and Exposures (CVE) databases, open-source monitoring dashboards, proprietary databases, active exploitation databases, and threat intelligence data sources.

The system 410 is configured to perform various embodiments disclosed herein. Specifically, the system 410 is configured to implement processes for event modeling as discussed with reference to FIG. 2.

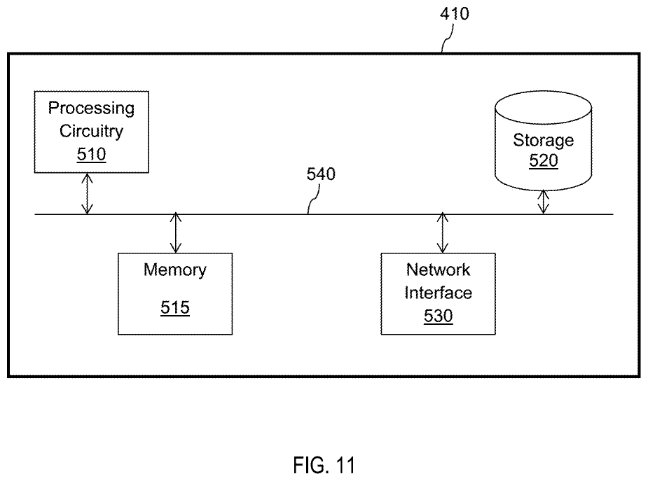

The system 410 may be implemented as a physical machine, a virtual machine, or a combination thereof. A block diagram of an example depicting a physical machine implementation is discussed below with reference to FIG. 11. A virtual machine may be any virtual software entity, such as a software container, a micro service, a hypervisor, and the like.

The database 430 may store the event catalogs, the hazard tables, the exceedance probability curves and data, or any other report that can be generated according to the disclosed embodiments. The database 430 may be a relational database or a NoSQL type of database such as, but not limited to, MongoDB. Examples of relational databases may include, but are not limited to, Oracle®, Sybase®, Microsoft SQL Server®, Access®, Ingres®, and the like. In an embodiment, the database 430 may be a plurality of logical entities residing in the same physical structure.

In an embodiment, the optional database 430 may be included in the system 410. In an alternate embodiment, the optional data store may be realized as separate components connected directly with the network 440, with the system 410, or both.

It should be noted that the embodiments disclosed herein are not limited to the specific architecture illustrated in FIG. 10, and that other architectures may be equally used without departing from the scope of the disclosed embodiments. Specifically, the system 410 may reside in a cloud computing platform, a datacenter, and the like. The cloud computing platform may be a private cloud, a public cloud, a hybrid cloud, and the like. Moreover, in an embodiment, there may be a plurality of systems operating as a distributed system. Further, the database 430 may be distributed as well. In some implementations, the system 410 may be an internal component or instance of any of the data sources 420. In an embodiment, the system 410 may include one or more data stores.

FIG. 11 shows an example block diagram of the system 410, according to an embodiment. The system 410 includes a processing circuitry 510 coupled to a memory 515, a storage 520, and a network interface 530. In an embodiment, the components of the system 410 may be communicatively connected via a bus 540, e.g., PCIe or other high-speed data bus.

The processing circuitry 510 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, graphics processing units (GPUs), tensor processing units (TPUs), general-purpose microprocessors, microcontrollers, and digital signal processors (DSPs), and the like, or any other hardware logic components that can perform calculations or other manipulations of information.

The memory 515 may be volatile (e.g., RAM, etc.), non-volatile (e.g., ROM, flash memory, etc.), or a combination thereof. In one configuration, computer readable instructions to implement one or more embodiments disclosed herein may be stored in the storage 520.

In another embodiment, the memory 515 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 510 to perform the various processes described herein.

The storage 520 may be magnetic storage, optical storage, and the like, and may be realized, for example, as flash memory or other memory technology, CD-ROM, Digital Versatile Disks (DVDs), or any other medium which can be used to store the desired information.

The network interface 530 allows the system 410 to communicate with the at least one various data sources or databases. It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computer-implemented method for assessing the risk presented by future vulnerabilities within an organization's technology and third party services, comprising:
accessing a catalog containing one or more descriptors for a plurality of previously reported vulnerabilities;
referencing the one or more descriptors, classifying technologies affected by the plurality of previously reported vulnerabilities according to product type;
referencing the one or more descriptors, classifying technologies affected by the plurality of previously reported vulnerabilities according to vendor;
accessing additional data characterizing the exploitability, severity and risk of individual vulnerabilities within the catalog;
based on the additional data, computing a product-type risk adjuster for each of the previously reported vulnerabilities;
based on the additional data, computing a vendor risk adjuster for each of the previously reported vulnerabilities;
simulating a number of cyber events, each embodying one of the plurality of vulnerabilities included in the catalog, to predict whether an organization is affected by the simulated cyber event, wherein the simulating cyber event simulates malicious activity in the organization, and wherein the simulation is adjusted by the product-type risk adjustor and the vendor risk adjustor; and
estimating a damage of the cyber event on the organization by employing a damage function.

2. The method of claim 1, wherein the event catalog comprises a snapshot of CVE and EPSS data.

3. The method of claim 1, wherein the additional data comprises a snapshot of EPSS data.

4. The method of claim 1, wherein computing the risk adjustors includes:
generating a risk score and normalizing the risk scores to a benchmark for each given modeled entity.

5. The method of claim 1, wherein estimating the damage includes generating an exceedance probability (EP) curve for the cyber event.

6. The method of claim 5, wherein generating the exceedance probability (EP) curve further comprises:
calculating an annual exceedance probability (AEP), wherein the AEP is calculated by summing damages of each year.

7. The method of claim 5, further comprising generating a visualization of the EP curve.

8. The method of claim 1, wherein simulating the cyber event further comprises:
simulating the cyber event via a Monte Carlo simulation.

9. A non-transitory computer readable medium having stored thereon instructions for causing a processing circuitry to execute a process for assessing the risk presented by future vulnerabilities within an organization's technology third party services, the process comprising:
accessing a catalog of reported vulnerabilities containing one or more descriptors for a plurality of previously reported vulnerabilities in technologies;
referencing the one or more descriptors, classifying technologies affected by the plurality of cyber events according to product type;
referencing the one or more descriptors, classifying technologies affected by the plurality of cyber events according to vendor;
accessing additional data characterizing the exploitability, severity and risk of individual vulnerabilities within the catalog;
based on the additional data, computing a product-type risk adjuster for each of the previously reported vulnerabilities;
based on the additional data, computing a vendor risk adjuster for each of the previously reported vulnerabilities;
simulating a plurality of cyber events, each embodying one of the plurality of vulnerabilities included in the catalog, to predict whether an organization is affected by the simulated cyber event, wherein the simulating cyber event simulates malicious activity in the organization, and wherein the simulation is adjusted by the product-type risk adjustor and the vendor risk adjustor; and
estimating a damage of the cyber event on the organization by employing a damage function.

10. A system for calculating technology risk, comprising:
a processing circuitry; and
a memory, the memory containing instructions that, when executed by the processing circuitry, configure the system to:
excess a cyber event catalog containing one or more descriptors for a plurality of previously reported vulnerabilities in technologies;
reference the one or more descriptors, classify technologies affected by the plurality of cyber events according to product type;
reference the one or more descriptors, classify technologies affected by the plurality of cyber events according to vendor;
accessing additional data characterizing the exploitability, severity and risk of individual vulnerabilities within the catalog;
based on the additional data, computing a product-type risk adjuster for each of the previously reported vulnerabilities;
based on the additional data, computing a vendor risk adjuster for each of the previously reported vulnerabilities;
simulate a plurality of cyber events, each embodying one of the plurality of vulnerabilities cyber events included in the catalog, to predict whether an organization is affected by the simulated cyber event, wherein the simulating cyber event simulates malicious activity in the organization, and wherein the simulation is adjusted by the product-type risk adjustor and the vendor risk adjustor; and
estimate a damage of the cyber event on the organization by employing a damage function.

11. The system of claim 10, wherein the event catalog comprises a snapshot of CVE and EPSS data.

12. The system of claim 10, wherein estimating the damage includes generating an exceedance probability (EP) curve for the cyber event.

13. The system of claim 12, wherein generating the exceedance probability (EP) curve further comprises:
calculating an annual exceedance probability (AEP), wherein the AEP is calculated by summing damages of each year.

14. The system of claim 12, wherein the system is further configured to generate a visualization of the EP curve.
